(19) United States
(12) Patent Application Publication
(10) Pub. No.: US 2023/0398472 A1
(43) Pub. Date: Dec. 14, 2023

(54) ARRANGEMENT AND METHOD FOR CONTROLLING PRESSURE FILTER

(71) Applicant: METSO OUTOTEC FINLAND OY, Tampere (FI)

(72) Inventors: Mikko Pulli, Lappeenranta (FI); Leena Tanttu, Lappeenranta (FI); Mika Kosonen, Lappeenranta (FI); Sakari Kauvosaari, Kurkimaki (FI)

(73) Assignee: METSO OUTOTEC FINLAND OY, Tampere (FI)

(21) Appl. No.: 18/249,859

(22) PCT Filed: Oct. 29, 2021
(86) PCT No.: PCT/FI2021/050736

§ 371 Date: Apr. 20, 2023

(30) Foreign Application Priority Data
Oct. 30, 2020 (FI) 20206090

(51) Int. Cl. B01D 25/28; B01D 25/164; B01D 29/82; G01N 27/22

(52) U.S. Cl. CPC B01D 25/285; B01D 25/164; B01D 29/82; G01N 27/223

(57) ABSTRACT

Disclosed is an arrangement and method for controlling a pressure filter. The arrangement comprises the pressure filter for solid-liquid separation for producing a filter cake and a moisture analyzer for providing an indication of moisture content of the filter cake. One or more controllers may be used for utilizing the indication of moisture content to set a drying time for the solid-liquid separation.

### FIELD

The present disclosure relates to pressure filters. In particular, the disclosure relates to controlling a pressure filter.

### BACKGROUND

Filtration cycle is traditionally controlled by recipes, which are divided to different subroutines. Every subroutine has operating parameters affecting the pressure filter performance. The operating parameters are entered manually in a manner, which does not take into account changes in feed characteristics or filter media condition.

### OBJECTIVE

An objective is to alleviate the disadvantages mentioned above.

In particular, it is an objective to provide pressure filtering with improved process control and reduced need for manual intervention.

Additionally, it is an objective to provide pressure filtering that can automatically stabilize output with respect to variations in feed quality.

It is also an objective to increase productivity with optimized solid-liquid separation cycle for pressure filtering.

For example, it is an objective to optimize balancing for pressure filtering between energy consumption and output quality, including consistency of output.

Furthermore, it is an objective to improve flexibility of pressure filter operation and control even under changing process conditions, and improve process visibility.

### SUMMARY

In accordance with the present disclosure, it has been found that various improvements to operating a pressure filter may be realized by measuring an indication of moisture content of a filter cake produced by the pressure filter and using this as a controlled variable for the pressure filter. In particular, it has been found that multivariable control may be efficiently utilized. Here, it has also been found that an indication of operating capacity of the pressure filter may be used together with the indication of moisture content as controlled variables to markedly improve the operation of the pressure filter. Automatic process control with the controlled variable(s) allows marked improvements with respect to manual operation of the pressure filter, where laboratory samples of filter cakes are collected only occasionally for quality monitoring, so that there is no immediate response to process changes. Moreover, any possibility to change operating parameters of the pressure filter in the right direction in manual operation is based on the operators' ability to understand the process and the filtration theory. Changes in the feed for the pressure filter may be relatively rapid, for example, changes in feed density, or slow, such as clogging of the filter medium. Automatized measurement of the controlled variable(s) allows any changes in their values to be rapidly responded to with one or more control operations. In turn, automatized performance of the control operation(s) allows the reaction time to the changes to be markedly reduced. Each control operation can be associated with a setpoint value, which may be provided by optimization of the controlled variable(s). In the context of the present disclosure, it has been determined that particular operational improvements may be obtained when the control operations include setting a drying time and, optionally, a feed amount and/or a pressing amount for the pressure filter. Each of the control operations may thus be associated with optimizing one operating phase of the pressure filter. Each of the control operations may correspond to a manipulated variable for controlling the pressure filter. In addition to the drying time, the manipulated variables may include a feed amount, such as a feed weight, and/or a pressing amount, such as a pressing time or a pressing pressure.

Herein, an of moisture content may refer to the moisture content itself or to one or more parameter values indicative of the moisture content. As an example, it may refer to an average of more than one measurement of moisture content of a single filter cake at different locations. The moisture content may correspond to residual moisture of the filter cake. Similarly, an indication of operating capacity may refer to the operating capacity or to one or more parameter values indicative of the operating capacity. The operating capacity may correspond to the amount of filter cake produced within a time period. The aforementioned applies correspondingly to any other indications referred to hereinbelow. An “indication” may herein refer to one or more parameter values.

According to a first aspect, an arrangement for controlling a pressure filter is disclosed. The arrangement comprises the pressure filter for solid-liquid separation for producing a filter cake and a moisture analyzer for providing an indication of moisture content of the filter cake. The indication of moisture content can be utilized to set a drying time for the solid-liquid separation. The arrangement may comprise one or more controllers for this purpose. Optimizing drying time, in particular, may allow marked improvement in the performance of the pressure filter since drying is an expensive phase in the solid-liquid separation process. This is particularly notable for air drying due to energy used to generate compressed air. The one or more controllers may be configured to set one or more setpoint values for associated control operation(s) of the pressure filter. Automated moisture sampling and parameter adjustment may significantly reduce inputs required from human operators.

In an embodiment, the moisture analyzer is or comprises a microwave analyzer, a capacitive sensor or a near-infrared sensor. This has been found to provide improved reliability so that setpoint values for the particular control operations disclosed herein, including the drying time, may be calculated accurately. Particular advantages have been observed with a microwave analyzer. In a further embodiment, the moisture analyzer has an accuracy of ±0.5 w %, which has been found to markedly improve the control performance. Any combination of the aforementioned devices may also be used.

In an embodiment, the arrangement is arranged for setting the drying time utilizing indications of moisture content provided from more than one solid-liquid separation cycles of the pressure filter. This allows mitigating fast changes to the setpoint(s) due to measurement errors or unexpected stops during the cycle.

In an embodiment, the one or more controllers comprises a multivariable controller. This is for utilizing the indication of moisture content to set the drying time for the solid-liquid separation and it allows the control of the pressure filter to be notably improved with multivariable optimization. This includes multiple controlled variables and/or multiple manipulated variables, where the manipulated variable(s) can be manipulated through control operation(s). For a pressure filter in particular, it allows one or more targets, such as the controlled variables disclosed herein (or the values thereof), to be (simultaneously) optimized with optimized control operations at multiple separate operating phases for the solid-liquid separation. With multivariable optimization, all references to “setting” one or more setpoint values, such as the drying time, disclosed herein may include setting any combination of one or more setpoint values for the controlled variables, in particular setting a setpoint value for all the controlled variables. The multivariable controller can produce the multiple setpoint values simultaneously as a result of a single optimization problem, thereby optimizing the performance of the pressure filter across multiple control operations. Importantly, the control operation(s), and the control value(s) thereof, may correspond to manipulated variables for the multivariable controller, with the indication(s), in particular those of the moisture content and optionally the operating capacity, acting as controlled variable(s) for the multivariable controller.

In an embodiment, the one or more controllers comprises a multivariable MPC (model predictive control) controller. This is for utilizing the indication of moisture content to set the drying time for the solid-liquid separation and it not only provides the modeling benefits of model predictive control and the abovementioned effects of multivariable control but additionally allows improved integration of the solid-liquid separation with one or more upstream control processes, information of which may thereby be utilized for the solid-liquid separation process control at the pressure filter. This allows dynamics of the upstream processes to be better accounted for the solid-liquid separation. Although one of the main advantages of MPC is to handle slow response dynamics, it is also applicable for controlling batch operating equipment, like the pressure filter. An advantage here is its inbuilt ability to consider the process constraints and desired prioritization between controlled variables.

In an embodiment, the arrangement is arranged for additionally utilizing the indication of moisture content to set a pressing amount of the pressure filter. This has been found to allow optimized control at a specific key operating phase for the solid-liquid separation to markedly improve the operational performance of the pressure filter.

In an embodiment, the arrangement comprises one or more weight sensors for providing an indication of the weight of the filter cake. This can be used for providing an indication of the operating capacity of the pressure sensor. This, in turn, allows efficiently utilizing the setting of a feed amount as a manipulated variable as it effectively reduces the risk of overfilling the filter chamber of the pressure filter, thereby risking breakage of the pressure filter.

In an embodiment, the pressure filter comprises one or more load cells for providing an indication of the weight of the filter cake. This allows providing an indication of the operating capacity of the pressure sensor. In particular, it can be used to provide the indication before discharge of the filter cake from a filter chamber of the pressure filter. With the load cell(s) the accuracy for the indication of the operating capacity can be improved. This in turn allows marked improvement in the performance of the pressure filter as it can be operated closer to its limits without risking breakage due to overfilling.

In a further embodiment, the arrangement is arranged for utilizing the indication of weight to set a feed amount for the pressure filter. This allows efficiently utilizing the feed amount as a controlled manipulated variable to allow the pressure filter to be operated closer to its maximum capacity while managing the risk of overfilling the filter chamber. The indication of weight may be utilized for providing an indication of capacity of the pressure filter.

In an embodiment, the arrangement is arranged for simultaneously utilizing the indication of moisture content and an indication of operating capacity of the pressure filter for setting the drying time and, optionally, a feed amount for the pressure filter and/or a pressing amount of the pressure filter. This allows improving the simultaneous optimization of both the quality and efficiency of the solid-liquid separation, optionally across several key operating phases.

In an embodiment, the arrangement comprises one or more sensors for providing an indication of quality of a washing phase of the solid-liquid separation. This is for setting one or more setpoint values such as the drying time and/or a control value for the washing phase i.e. for for washing the filter cake. The latter allows directly optimizing one or more control operations for the washing phase, such as was time and/or wash medium amount.

In an embodiment, the arrangement comprises one or more sensors for providing an indication of pH, electrical conductivity or turbidity of a filtrate produced by the pressure filter. This is for setting one or more setpoint values such as the drying time and/or a control value for washing the filter cake. This may be used for improved control over the filtrate of the pressure filter, which may be important in some applications. When the solid-liquid separation comprises washing of the filter cake, any or all of the aforementioned indications may be utilized for setting one or more control values for washing such as a wash time and/or a wash medium amount.

According to a second aspect, a method for controlling a pressure filter for solid-liquid separation is disclosed. The method comprises receiving an indication of moisture content of a filter cake produced by the pressure filter for the solid-liquid separation and utilizing the indication of the moisture content for setting a drying time for the solid-liquid separation.

The method may additionally comprise any combination of operations indicated above for causing the setting of one or more setpoint values. For example, the method may comprise additionally receiving an indication of operating capacity of the pressure filter and utilizing it for setting one or more setpoint values for control operations, such as the drying time. The method may also comprise utilizing the indication of moisture content and/or the indication of operating capacity for setting a feed amount for the pressure filter and/or a pressing amount of the pressure filter. The method may involve multivariable optimization, for example by model predictive control, for setting the drying time and, optionally, the feed amount and/or the pressing amount.

The method may comprise receiving any number of additional indications, which may be used utilized together with other indications for setting any setpoint values. The method may comprise receiving an indication of the weight of the filter cake and utilizing it for providing the indication of operating capacity. The method may comprise receiving an indication of quality of a washing phase of the solid-liquid separation and utilizing it for setting one or more setpoint values such as the drying time and/or a control value for the washing phase, such as a wash time and/or a wash medium amount. The method may comprise receiving an indication of pH and/or electrical conductivity of a filtrate produced by the pressure filter, such as a wash filtrate produced during the washing of the filter cake, and utilizing it for setting one or more setpoint values such as the drying time. Any number of indications may be utilized simultaneously for setting the drying time and, optionally, the feed amount and/or the pressing amount, but also other control values such as wash time and/or wash medium amount, if needed. The indication(s) utilized may be received from more than one solid-liquid separation cycles of the pressure filter.

In an embodiment, the method comprises receiving an indication weight of the filter cake. The indication of weight is utilized together with the indication of the moisture content for setting the drying time, a feed amount and, optionally, a pressing amount for the pressure filter.

According to a third aspect, a controller configured to cause the method of according to the second aspect or any of its embodiments to be carried out. The controller may be configured to set any number of setpoint values for controlling the pressure filter. It may be configured for utilizing any combination of the controlled variables and/or the manipulated variables as indicated in this disclosure.

A computer program product may also be provided, the computer program product comprising instructions which, when the program is executed by a computer, cause the computer to cause the method according to the second aspect to be carried out.

It is to be understood that the aspects and embodiments described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding and constitute a part of this specification, illustrate examples and together with the description help to explain the principles of the disclosure. In the drawings:

FIG. 1a illustrates solid-liquid separation with a pressure-filter according to an example,

FIG. 1b illustrates solid-liquid separation with a pressure-filter according to another example, FIG. 2 illustrates an arrangement for controlling a pressure filter according to an example,

FIG. 3 illustrates a control system for controlling a pressure filter according to an example, and

FIG. 4 illustrates a method for controlling a pressure filter according to an example.

Like references are used to designate equivalent or at least functionally equivalent parts in the accompanying drawings.

### DETAILED DESCRIPTION

The detailed description provided below in connection with the appended drawings is intended as a description of examples and is not intended to represent the only forms in which the example may be constructed or utilized. However, the same or equivalent functions and structures may be accomplished by different examples.

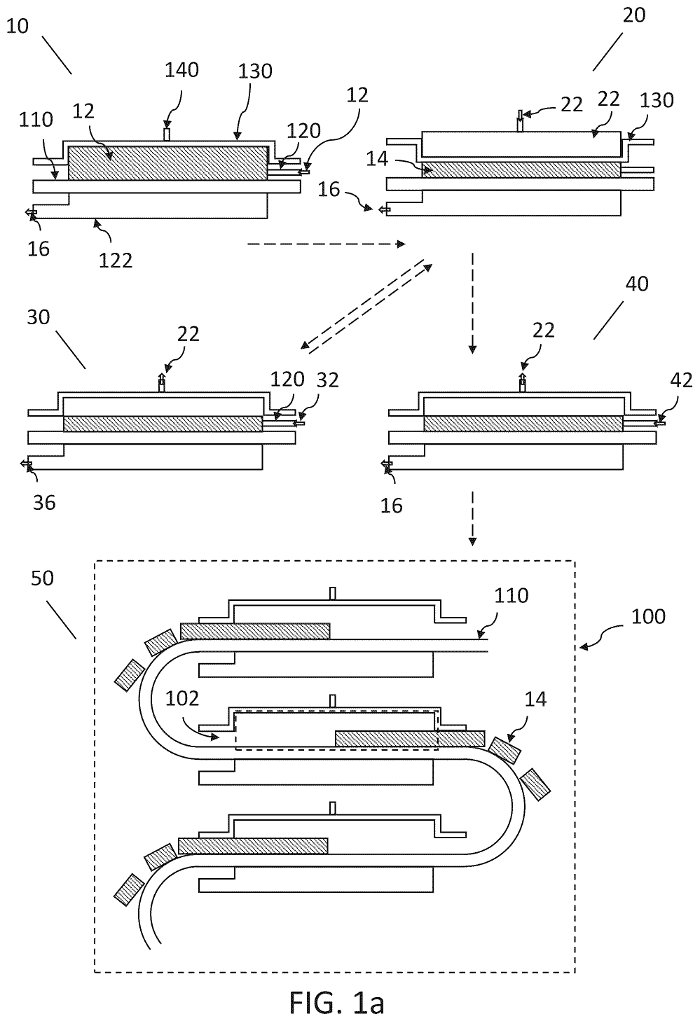

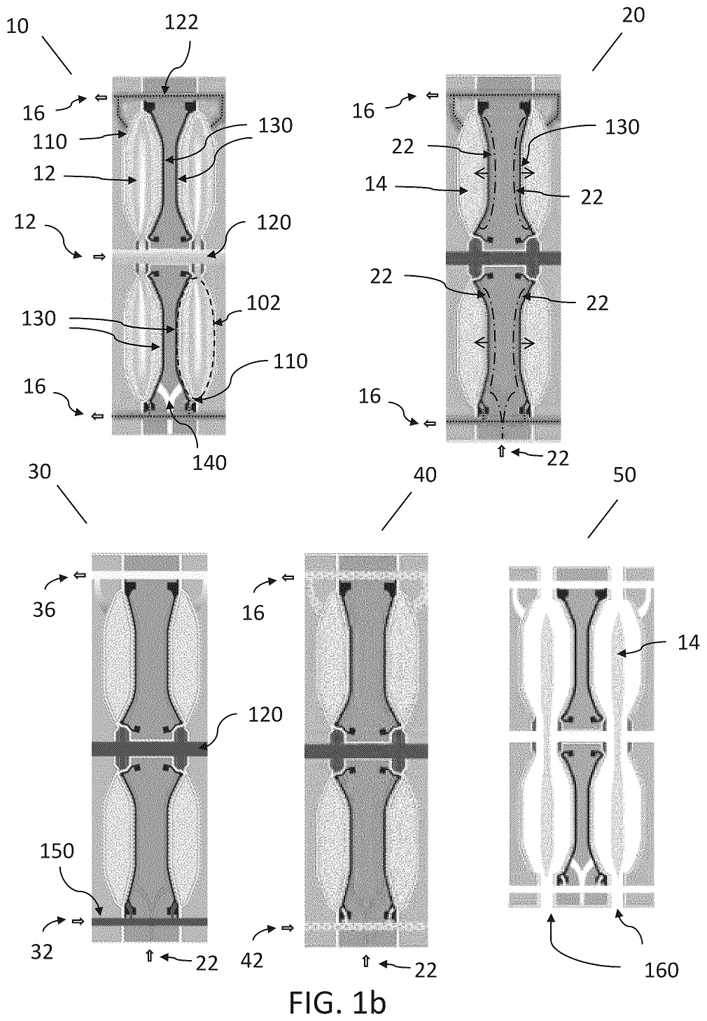

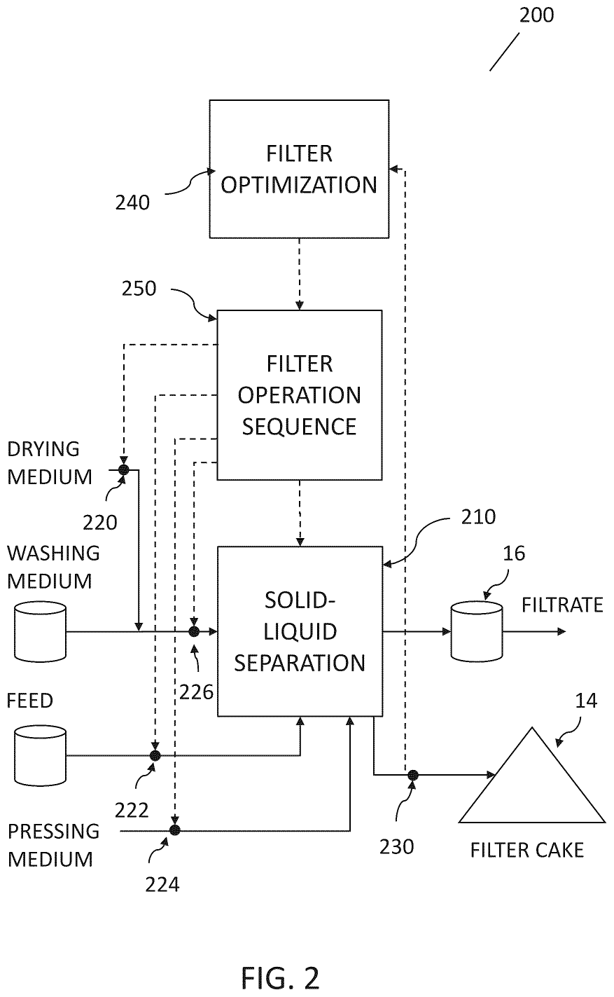

FIG. 1a illustrates solid-liquid separation (also referred to herein as “the separation”) with a pressure filter 100 according to an example (in the figure, the pressure filter is illustrated by a part of a plate pack of a pressure filter). It is a process, where the pressure filter receives a feed 12, such as slurry, from which liquid is removed during the solid-liquid separation to produce a filter cake 14 (also referred to herein as “the cake”). The filter cake has a reduced moisture level in comparison to the feed, while the liquid is removed as a filtrate 16 of the pressure filter. The pressure filter is a batch operating device, configured to separately process subsequent batches of feed. During one operating cycle of the pressure filter (also referred to therein as a “solid-liquid separation cycle”), one batch is processed. The pressure filter may be an automatic filter, which can be configured to process multiple subsequent patches automatically. The pressure filter may thereby be configured to perform multiple subsequent operating cycles automatically.

The pressure filter 100 may be configured for various applications. The pressure filter may be a concentrate filter, in which case its optimization may be focused on optimizing operating capacity and/or energy consumption of the pressure filter but also operating quality, in particular in terms of residual moisture of the filter cake. It may also be a bulk materials and/or tailings filter. The pressure filter may be primarily purposed for providing as an end product the filtrate 16 and/or the filter cake 14. In particular, the pressure filter may be a minerals processing industry filter, such as a tailings filter, or a chemical process industry filter, such as a pigment-production filter. In the former case, the feed 12 may be concentrates slurry from an upstream mineral processing process. Particularly in the latter case, the solid-liquid separation may include washing as an important phase of the process. As an example, the pressure filter may be a pf filter, an ffp (fast-opening filter press) filter or a pf-ds (double-sided) filter. In general, the pressure filter may be a horizontal or vertical pressure filter and/or a double-sided filter. Horizontal pressure filters have horizontally positioned filter plates, whereas vertical pressure filters have vertically positioned filter plates. While FIG. 1a is illustrated in terms of a horizontal pressure filter, such as a pf filter, the principles described with reference to the figure are applicable to other types of pressure filters as well. As an additional example, FIG. 1b is illustrated in terms of a vertical pressure filter, such as a ffp filter.

The pressure filter 100 may comprise one or more filter chambers 102, into which the feed can be (separately) directed for the separation. After the separation, the filter cake 14 may then be (separately) discharged 50 from the filter chamber(s). In some pressure filters, e.g. a pf filter, the filter cake may be conveyed in and out of the filter chamber on a filter medium 110, which may extend through multiple filter chambers. In some pressure filters, e.g. an ffp filter, multiple filter chambers may have their own individual filter media. The pressure filter may be arranged for the feed to be directed into the filter chambers and/or discharged from the filter chambers simultaneously, for example for fp filters, or sequentially, for example for ffp filters. For example, the conveyor may extend through multiple filter chambers for this purpose. As an example, two or more filter chambers may be superposed to provide a compact structure for the pressure filter. This also allows the filter cake to be discharged by gravity. The pressure filter or the arrangement may also comprise one or more conveyors, such as conveyor belts, for transporting the filter cake after it has been discharged from the filter chamber.

The solid-liquid separation may comprise multiple phases (also referred to herein as “operating phases”) such as a filtration phase 10, a pressing phase 20 and a drying phase 40. In one example, the separation comprises the aforementioned three phases in said order, as indicated also by dashed arrows in the figure. The separation may additionally comprise one or more washing phases 30, which may be after the pressing phase 20, as indicated also by dashed arrows in the figure. Each washing phase 30 may be followed by an additional pressing phase 20, as indicated also by dashed arrows in the figure.

The filtration phase 10 comprises directing the feed 12 into the pressure filter 100, in particular into the one or more filter chambers 102 thereof. This may be performed by pumping. A feed amount may herein refer to the amount of feed fed into the filter chamber for a single operating cycle or one or more parameter values indicative thereof. The pressure filter may comprise one or more distribution channels 120, such as pipes and/or hoses, for directing the feed into the pressure filter and into the one or more filter chambers. The filtrate 16 flows through a filter medium of the pressure filter, such as a filter cloth, into a filtrate collection area 122 of the pressure filter, from which it may be discharged for disposal or for further use. The filtered material forms the filter cake 14. It can be collected on the filter medium.

The pressing phase 20 comprises pressing the filter cake 14 with a pressing pressure utilizing a pressing unit 130 of the pressure filter 100. The pressing phase 20 may also comprise diaphragm pressing, in which case the pressing unit can be a diaphragm, such as a rubber diaphragm. The pressing unit presses the filter cake 14 against the filter medium, thereby pressing the filtrate 16 from the cake through filter medium. The filtrate may again be discharged from the filtrate collection area 122. The pressing pressure may be generated by a pressing fluid 22, which may be gas or liquid, such as air and/or water. For this purpose, the pressure filter may comprise one or more pressing fluid channels 140 for directing the pressing fluid against the pressing unit. The pressing pressure may correspond to a differential pressure, which is the difference in an overpressure within the pressure filter and atmospheric pressure, or a pressing delta-pressure, such as a pressure difference between a nominal pressing pressure and a feed manifold pressure.

The washing phase 30 comprises feeding wash medium 32, such as was liquid, into the one or more filter chambers 102 for washing the filter cake 14. For this purpose, the same distribution channel(s) 120 may be utilized as for the directing of the feed 12 into the filter chamber(s). As the wash medium fills the filtration chamber, the pressing unit can be lifted from the filter cake 14 by the pressure exerted by the wash medium on the pressing unit. For diaphragm pressing, remaining pressing fluid 22 may also be pushed out by the diaphragm. Again, a filtrate of the pressure filter 100 may be discharged from the filtrate collection area 122, in this case the filtrate being a wash filtrate 36.

The solid-liquid separation process may also comprise one or more separate phases for washing the one or more distribution channels 120.

The drying phase 40 comprises feeding drying medium 42, such as a drying gas, into the one or more filter chambers 102 for drying the filter cake 14. For this purpose, the same distribution channel(s) 120 may be utilized as for the directing of the feed 12 into the filter chamber(s). In particular, air drying can be utilized, in which case the drying medium may comprise or consist of compressed air. The pressure filter 100 may comprise one or more compressors such as air compressors for feeding the drying medium into the filter chamber(s). The pressure filter can be configured for feeding the drying medium into the filter chamber(s) for a set drying time, which may be variable between subsequent drying phases of subsequent operating cycles i.e. from one operating cycle to another. The drying time may thereby correspond to a time a compressor of the pressure filter is used for drying the filter cake for the solid-liquid separation. As the drying medium fills the filtration chamber, the pressing unit can be lifted from the filter cake 14 by the pressure exerted by the drying medium on the pressing unit. For diaphragm pressing, remaining pressing fluid 22 may also be pushed out by the diaphragm. A filtrate 16 may again be discharged from the filtrate collection area 122, for example by the flow of drying medium pushing it out. The flow of drying medium through the cake reduces the moisture content of the cake.

After the drying phase 40, the filter cake 14 may be discharged from the filter chamber 102. However, the pressure filter may comprise one or more weight sensors, such as load cells, for providing an indication of the weight of the filter cake 14 after the drying phase 40, for example just before discharging the cake from the filter chamber or the pressure filter altogether.

FIG. 1b illustrates the solid-liquid separation with a pressure filter 100 according to another example (also in this figure, the pressure filter is illustrated by a part of a plate pack of a pressure filter). In this example, the pressure filter is a vertical pressure filter such as an ffp filter. The illustration is further provided in terms of a double-sided filter. In the illustrated example, four filter chambers 102 have been integrated to utilize the same distribution channel for directing feed into the filter chambers.

The solid-liquid separation may here comprise the same operating phases as referred to in the context of FIG. 1a. It may also comprise any combination of the functional and/or structural features referred therein.

Regarding the washing phase(s) 30, it is noted that the wash medium 16 may be fed into the filter chamber(s) 102 through the same distribution channel(s) 120 as for the directing of the feed 12 into the filter chamber(s) and/or through one or more additional channels such as corner channels 150. Only the latter alternative is illustrated in the figure. The additional channel(s) may also be configured for discharging filtrate 16, 36 during one or more other operating phases of the pressure filter. The additional channel(s) may be configured for discharging wash filtrate 36 during the washing phase according to the first alternative since they are not used for feeding the wash medium during this phase. The solid-liquid separation may also include a first washing phase, where wash medium is fed into the filter chamber(s) through the same distribution channel(s) as for the directing of the feed into the filter chamber(s) and a second washing phase, where wash medium is fed into the filter chamber(s) through the one or more additional channels. The first washing phase may be already after the filtration phase 10 and before the (first) pressing phase 20.

For the vertical pressure filter, the pressing unit 130 may be maintained active through one or more phases in addition to the pressing phase(s) 20. As illustrated, it may remain active through the washing phase(s) 40 and/or the drying phase 40. Correspondingly, the pressing fluid 22 may be maintained in the pressing fluid channel(s) 140 through the corresponding phase(s). Also the feed of the pressing fluid can be maintained active for maintaining the pressing pressure.

The pressure filter may comprise one or more drying channels for feeding the drying medium 42 into the one or more filter chambers 102 for drying the filter cake 14. For this purpose, the additional channels such as corner channels 150 may be utilized, in particular the channels for feeding the wash medium 16 into the filter chamber(s).

The vertical pressure filter may comprise one or more vertical discharge channels 160 for discharging 50 the filter cake(s) 14. These channels may separate from the distribution channel(s) 120 for directing of the feed 12 into the filter chamber(s). The vertical discharge channel(s) may be openable for discharging the filter cake(s).

FIG. 2 illustrates an arrangement 200 for controlling the pressure filter 100 according to an example. With the arrangement, an indication of moisture content of a filter cake 14 produced by the pressure filter is received and utilized for setting a drying time for solid-liquid separation 210, where the solid-liquid separation may correspond to any of the examples for solid-liquid separation disclosed above with reference to FIG. 1. For the solid-liquid separation, the arrangement is configured for controlling the drying medium through setting a drying time 220. For the same purpose, the arrangement may be configured for controlling the feed through setting a feed amount 222 for the pressure filter and/or for controlling the pressing unit through setting a pressing amount 224 of the pressure filter. In an embodiment, the manipulated variable for the feed amount may correspond to a feed weight. Alternatively or additionally, the manipulated variable(s) for the pressing amount may correspond to a pressing pressure and/or a pressing time. The arrangement may further be configured for controlling the wash medium, such as wash liquid, through setting one or more control values for the washing phase 226 such as a wash time and/or a wash medium amount. Further control values are also possible. Any or all of the control values may be provided as setpoints for control operations. The control value(s) may be set automatically so that different control value(s) may be automatically used for two subsequent operating cycles. The control value(s) may directly correspond to the control operations, and thereby also manipulated variables for multivariable optimization or MPC. One or more manipulated variables may be used for controlling the pressure filter during any single operating phase.

The solid-liquid separation 210 is performed by the pressure filter 100. As a result of the separation, a filtrate 16 and a filter cake 14 is produced. The arrangement 200 is configured to provide one or more indications of quality and/or efficiency of the solid-liquid separation and utilize the indication(s) to set one or more control values, including at least the drying time but optionally also the feed amount and/or the pressing amount or other control values. The arrangement, or the pressure filter, may comprise one or more weight sensors, such as load cells of the pressure filter, for controlling the feed amount. The feed amount may also be controlled with feeding time and/or feeding pressure, for example in the absence of weight sensors. The arrangement, or the pressure filter, may comprise a feed manifold pressure sensor and/or a feed density sensor for controlling one or more controlled variables. The arrangement, or the pressure filter, may also comprise a pressing pressure sensor for controlling the pressing pressure. The arrangement may also comprise one or more of a feed, drying medium and wash medium flow transmitter for controlling one or more corresponding control values. Such additional instrumentation may help in performance evaluation and improve control accuracy. While any sensors, such as the additional instrumentation, may be integrated to the pressure filter, but they may often be more conveniently provided as separate parts of the arrangement. For example, they may be configured to be connected to a plant automation system. Any sensor separate from the pressure filter may be configured for transferring information to the filter via a bus communication.

The indication(s) of quality and/or efficiency of the solid-liquid separation 210 include at least an indication of moisture content of the filter cake 14. This allows efficient quality control of the separation. Here, quality may refer to accurately achieving a target value for the controlled variable, such as the moisture content, for one filter cake or batch and/or achieving uniformity for the target value across filter cakes of multiple batches. The arrangement 200 may comprise one or more moisture analyzers for providing the indication of moisture content. These may comprise a microwave analyzer for providing an indication of moisture content of a filter cake but other alternatives are also possible, including a capacitive sensor and or a near-infrared sensor for said purpose. The moisture analyzer(s) may be part of the pressure filter 100 or they may be separate. The indication of moisture content may be obtained by measuring the filter cake along its entire length and calculating an average value for use in control. It has been found that marked benefits may be obtained when the moisture content is measured with an accuracy of ±0.5 w %.

The indication(s) of quality and/or efficiency of the solid-liquid separation 210 may also include various other indications, in particular an indication of operating capacity of the pressure filter, which may be obtained utilizing an indication of weight of the filter cake produced by the pressure filter. Any sensors for obtaining the indication(s), including a weight sensor for providing the indication of weight, may be part of the pressure filter 100 or they may be separate The indication of operating capacity may be expressed in terms weight over time for the filter cake produced by the pressure filter, for example as tonnage per hour.

The indication(s) may be obtained automatically. The indication(s) may be obtained 230 by one or more measurements of the filter cake 14 after the solid-liquid separation 210, or after the drying phase 40 thereof. Alternatively or additionally, one or more of the indications may be obtained by one or more measurements of the filter cake 14 before the cake is discharged 50 from the filter chamber or from the pressure filter. In particular, an indication of weight of the filter cake 14 may be conveniently obtained while the filter cake is still in the filter chamber, when the pressure filter comprises one or more weight sensors such as load cells for this purpose. On the other hand, the arrangement may comprise a weight sensor such as a conveyor belt scale for obtaining the indication of weight after discharging the filter cake from the filter chamber or the pressure filter. Also as an example, an indication of moisture content may be obtained before and/or after discharging the filter cake from the filter chamber or the pressure filter. The arrangement may also comprise one or more timers for determining one or more indications of duration. The indication(s) of duration may correspond to the duration of one or more phases of the solid-liquid separation 210 or the total duration of the separation. The indication(s) of duration may be utilized for obtaining an indication of operating capacity of the pressure filter, for example by dividing an indication of weight of the filter cake by an indication of the total duration of the solid-liquid separation. The indication(s) of duration may also be utilized for controlling a feeding time and/or the pressing time.

As any or all indications may be obtained from a ready-made filter cake 14 after the solid-liquid separation 230, they may be utilized for setting one or more control values for any subsequent batch. An indication of moisture content of the filter cake and an indication of operating capacity of the pressure filter may be obtained from the same batch or from the same filter cake 14, in particular. However, indications of multiple different batches may also be used together, for example as an average value.

The arrangement is configured for utilizing the indication(s) of quality and/or efficiency of the solid-liquid separation 210 for setting one or more control values for the manipulated variables. The arrangement may comprise one or more controllers configured for this purpose. For example, the pressure filter 100 may comprise its own controller, which may perform any or all of the operations disclosed herein. On the other hand, the pressure filter may comprise a sub-controller which receives the one or more control values from a master controller for setting the control value(s) for its own operation, thereby only relaying the control value(s) set by the master controller. The separation of the one or more controllers to one or more sub-controllers and one or more master controllers allows remote control of the pressure filter.

Controlling the solid-liquid separation 210 utilizing the indication(s) involves determining an optimized set of one or more control values for the pressure filter 100. In FIG. 2, this is illustrated as filter optimization 240, which involves utilizing the indication(s) of quality and/or efficiency of the solid-liquid separation 210 for setting one or more control values for the manipulated variables. The one or more controllers can be configured for performing the filter optimization, for example by the master controller, for setting the control value(s). Where necessary, the arrangement and the one or more controllers may be configured for relaying the control value(s) to the pressure filter. Finally, the one or more controllers may be configured for locally setting the control values at the pressure filter for performing the solid-liquid separation, which can be performed for example by the sub-controller of the pressure filter. This corresponds to locally setting the control values for the filter operation sequence 250 of the pressure filter.

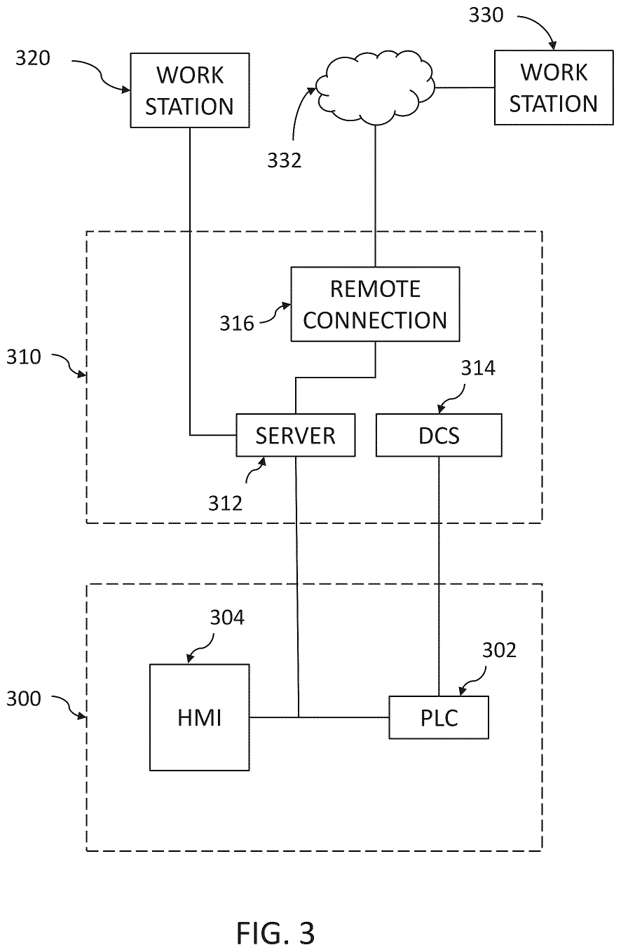

FIG. 3 illustrates a control system for controlling a pressure filter 100 according to an example. The control system may comprise or consist of the one or more controllers for utilizing the indication of moisture content to set a drying time for the solid-liquid separation. The one or more controllers may comprise a sub-controller and a master controller, where the sub-controller is the local process controller of the pressure filter, which may be directly integrated to the pressure filter, and the master controller is situated remotely from the pressure filter. The master controller may be configured for controlling multiple pressure filters.

The one or more controllers, for example the master controller, may be configured for receiving the one or more indications of quality and/or efficiency of the solid-liquid separation 210, including the indication of moisture content of a filter cake produced by the pressure filter 100 for the solid-liquid separation. The one or more controllers may then be configured for utilizing the indication(s) for setting one or more control values, such as the drying time, for the solid-liquid separation. The one or more controllers, for example the master controller, may be configured for determining the one or more control values by multivariable optimization utilizing the indication(s). For this purpose, the corresponding controller(s) may be a multivariable controller and/or a model predictive control (MPC) controller.

The multivariable controller may simultaneously set control value(s) for manipulated variable(s) (MV) in response to variance in value(s) of controlled variable(s) (CV). In multivariable control, there is not necessarily any direct relationship between individual controlled variables and manipulated variables, where one specific manipulated variable, for example drying time, would be adjusted directly to control one specific controlled variable, such as the indication of moisture content. Instead, controller outputs may be calculated as optimized result of a cost function. Here, the cost function may correspond to a sum comprising a penalty for predicted control error, a penalty for actuator position tracking, a penalty for actuator move suppression and penalty for violating given constraints.

Controller tuning may be separated in two parts. The first part involves building process models for each MV-CV relationship. This may be done by performing process step response trials and modelling the measured responses. During step response tests drying time and, optionally, feed amount may be modified manually. Effect to cake moisture may then be measured by a moisture analyzer as disclosed herein. The moisture analyzer can be calibrated for accuracy before performing step response tests. Step response tests for drying time and, optionally, feed amount may be done one by one, so that all other variables in filter recipe can remain unchanged during the tests. Collection and analysis of feed samples may also be performed during the step response tests. The second part involves parameterizing the controller cost function, i.e. describing how the penalties are calculated and how they are weighted against each other.

When calculating new setpoints for an upcoming operating cycle, setpoints from previous cycles may be taken into the account. By averaging multiple cycles, fast changes to setpoints due to measurement errors or unexpected stops during the cycle can be avoided. Same logic applies also to situations when filter is restarted after stoppage. For example, three cycles may be performed until new setpoints are calculated and taken into the use.

As an example, the pressing phase can be optimized based on pressure difference between pressing pressure and feed manifold pressure (i.e. delta pressure). The controller may be configured for receiving a measurement value for the delta pressure and calculating a new setpoint for the delta pressure based on its influence on the moisture content of the filter cake.

The master controller may comprise one or more server computers. The sub-controller may comprise a programmable logic controller (PLC) of the pressure filter. The one or more controllers may comprise one or more human-machine interfaces (HMI) for user interaction with the controller(s).

As an example, the arrangement 200 or the pressure filter 100 itself may comprise a sub-controller 302 such as a PLC controller of the pressure filter 100 and, optionally, a HMI 304. These may be coupled to a filter control panel 300. The sub-controller may be configured for connection to a master controller, which may comprise a server computer 312 and/or a distributed control system (DCS) 314, for example that of a plant automation system. These may be situated in an automation room 310. The server may be provided with remote connection 316, which may include a firewall. This allows the server 312 to be connected to one or more remote workstations 330, for example through intranet, internet or cloud connection. On the other hand, the server may also have one or more local connections to one or more workstations 320, which may be situated at a control room. Remote connectivity for controlling the pressure filter allows rapid support and fine-tuning of system parameters to address any issues and maximize optimizing performance.

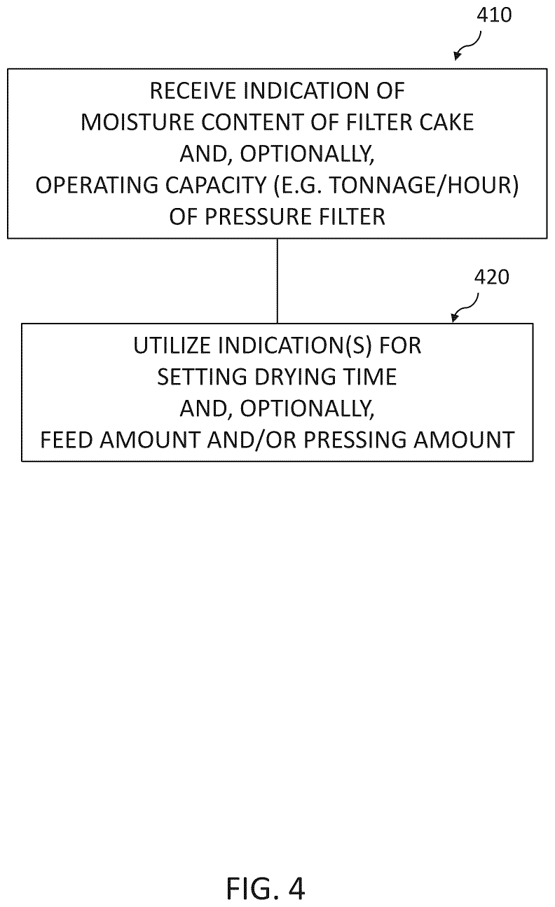

FIG. 4 illustrates a method for controlling a pressure filter 100 according to an example. The method comprises receiving 410 one or more indications of quality and/or efficiency of the solid-liquid separation 210, including an indication of moisture content of a filter cake produced by the pressure filter 100 for the solid-liquid separation 210. This may be performed or be caused to be performed by the one or more controllers, for example the master controller. The method also comprises utilizing 420 the indication(s), including the indication of the moisture content for setting one or more control values, including the drying time for the solid-liquid separation.

The method allows calculating new setpoint(s) for the manipulated variable(s) following changes in pressure filter performance. Thereby, drying medium usage, e.g. compressed air usage, in the drying phase may be optimized, which in turn optimizes energy consumption. However, it is determined that for a pressure filter the optimization dynamics are not isolated to separate phases but the optimization can be markedly improved by multivariable optimization including control values for other phases of the solid-liquid separation as well. The drying time may thereby be reduced by optimizing the pressing amount and/or feed amount, as well. The one or more controllers may be configured to calculate the control value(s) anew for one of more subsequent operating cycles of the pressure filter, for example for each subsequent cycle. Correspondingly, the arrangement 200 may be configured for automatically updating the control value(s) for a new operating cycle of the pressure filter, for example for each operating cycle.

The arrangement and the method disclosed allow optimizing filter cake residual moisture with respect to a target value by driving and/or maintaining it there. Main manipulated variable is drying time, which has been found to have marked influence on the residual moisture of the filter cake. Filter cake moisture may be driven towards a given residual moisture setpoint (e.g. 8-30 w %, where weight percentage values of 8-15, for example, may be used for mining applications and values of 15-30, for example, may be used for chemical industry applications) by controlling drying time between limit values.

It is noted that incomplete pressing phase does not remove enough fluid bound to the cake formed during the filtration phase. Liquid removal with the drying phase increases consumption of drying medium, such as compressed air, and increases operating cycle duration influencing the overall capacity of the pressure filter. On the other hand, too long pressing phase may cause the cake to be excessively squeezed making it difficult for the drying medium to flow through the cake in the drying phase. Unnecessarily long pressing phase also increases operating cycle duration for the solid-liquid separation. Pressing can in many cases be optimized based on pressure difference between the pressing pressure and the pressure within the distribution channel such as a distribution pipe. Fluid connection between these two pressure measurements is lost when free liquid is pressed out of the cake. Because of this phenomenon pressure in the distribution channel starts to decrease. Depending on the application, pressing can be stopped when certain pressure difference is reached.

Controlling feed amount has been found to markedly affect the operating capacity of the pressure filter. A limiting factor for the amount of feed pumped to a filter chamber is the volume of the chamber but the filter cake formed therein may have also other characteristics limiting the filter capacity including one or more of cake thickness, feeding time, compressibility and flow resistance. Targeting to maximum cake thickness may increase filtration time needlessly and influence also the subsequent pressing and drying phases. Filter optimizing may involve calculating an optimal feed amount where feeding and drying times are minimized, while taking into account the overall capacity of the pressure filter across the whole solid-liquid separation process. Feed amount can be conveniently controlled if the filter is equipped with one or more load cells.

The arrangement and/or the pressure filter may comprise at least one memory comprising computer program code. The at least one memory and the computer program code may be configured to cause the one or more controllers to cause any of the operations disclosed herein to be performed. In particular, this includes setting any control value(s) and/or utilizing any indication(s) for determining one or more control values.

The one or more controllers as described above may be implemented in software, hardware, application logic or a combination of software, hardware and application logic. The application logic, software or instruction set may be maintained on any one of various conventional computer-readable media. A “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The examples can store information relating to various processes described herein. This information can be stored in one or more memories, such as a hard disk, optical disk, magneto-optical disk, RAM, and the like. One or more databases can store the information used to implement the embodiments. The databases can be organized using data structures (e.g., records, tables, arrays, fields, graphs, trees, lists, and the like) included in one or more memories or storage devices listed herein. The databases may be located on one or more devices comprising local and/or remote devices such as servers. The processes described with respect to the embodiments can include appropriate data structures for storing data collected and/or generated by the processes of the devices and subsystems of the embodiments in one or more databases.

All or a portion of the embodiments can be implemented using one or more general purpose processors, microprocessors, digital signal processors, micro-controllers, and the like, programmed according to the teachings of the embodiments, as will be appreciated by those skilled in the computer and/or software art(s). Appropriate software can be readily prepared by programmers of ordinary skill based on the teachings of the embodiments, as will be appreciated by those skilled in the software art. In addition, the embodiments can be implemented by the preparation of application-specific integrated circuits or by interconnecting an appropriate network of conventional component circuits, as will be appreciated by those skilled in the electrical art(s). Thus, the embodiments are not limited to any specific combination of hardware and/or software.

The different functions discussed herein may be performed in a different order and/or concurrently with each other.

Any range or device value given herein may be extended or altered without losing the effect sought, unless indicated otherwise. Also any example may be combined with another example unless explicitly disallowed.

Although the subject matter has been de-scribed in language specific to structural features and/or acts, it is to be understood that the subject matter defined in the appended claims is not necessarily limited to the specific features or acts de-scribed above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The term ‘comprising’ is used herein to mean including the method, blocks or elements identified, but that such blocks or elements do not comprise an exclusive list and a method or apparatus may contain additional blocks or elements.

Although the invention has been the described in conjunction with a certain type of apparatus and/or method, it should be understood that the invention is not limited to any certain type of apparatus and/or method. While the present inventions have been described in connection with a number of examples, embodiments and implementations, the present inventions are not so limited, but rather cover various modifications, and equivalent arrangements, which fall within the purview of the claims. Although various examples have been described above with a certain degree of particularity, or with reference to one or more individual embodiments, those skilled in the art could make numerous alterations to the disclosed examples without departing from the scope of this specification.

1. An arrangement for controlling a pressure filter, the arrangement comprising:
the pressure filter for solid-liquid separation for producing a filter cake;
a moisture analyzer for providing an indication of moisture content of the filter cake;
one or more controllers for utilizing the indication of moisture content to set a drying time for the solid-liquid separation.

2. The arrangement according to claim 1, wherein the moisture analyzer comprises a microwave analyzer, a capacitive sensor or a near-infrared sensor.

3. The arrangement according to claim 1, arranged for setting the drying time utilizing indications of moisture content provided from more than one solid-liquid separation cycles of the pressure filter.

4. The arrangement according to claim 1, wherein the one or more controllers comprise a multivariable controller.

5. The arrangement according to claim 1, wherein the one or more controllers comprise a multivariable MPC (model predictive control) controller.

6. The arrangement according to claim 1, arranged for additionally utilizing the indication of moisture content to set a pressing amount of the pressure filter.

7. The arrangement according to claim 1, comprising one or more weight sensors for providing an indication of the weight of the filter cake.

8. The arrangement according to claim 1, wherein the pressure filter comprises one or more load cells for providing an indication of the weight of the filter cake.

9. The arrangement according to claim 7, arranged for additionally utilizing the indication of weight to set a feed amount for the pressure filter.

10. The arrangement according to claim 1, arranged for simultaneously utilizing the indication of moisture content and an indication of operating capacity of the pressure filter for setting the drying time and, optionally, a feed amount for the pressure filter and/or a pressing amount of the pressure filter.

11. The arrangement according to claim 1, wherein the solid-liquid separation comprises a washing phase and the arrangement comprises one or more sensors for providing an indication of quality of the washing phase for setting the drying time and/or a control value for washing the filter cake.

12. The arrangement according to claim 1, comprising one or more sensors for providing an indication of pH, electrical conductivity or turbidity of a filtrate produced by the pressure filter for setting the drying time and/or a control value for washing the filter cake.

13. A method for controlling a pressure filter for solid-liquid separation, the method comprising:
receiving an indication of moisture content of a filter cake produced by the pressure filter for the solid-liquid separation; and
utilizing the indication of the moisture content for setting a drying time for the solid-liquid separation.

14. The method according to claim 13, comprising receiving an indication weight of the filter cake; wherein the indication of weight is utilized together with the indication of the moisture content for setting the drying time, a feed amount for the pressure filter and, optionally, a pressing amount of the pressure filter.

15. A controller configured to cause the method of claim 13 to be carried out.

16. The arrangement according to claim 8, arranged for additionally utilizing the indication of weight to set a feed amount for the pressure filter.
